(19) United States
(12) Patent Application Publication
(10) Pub. No.: US 2012/0053969 A1
(43) Pub. Date: Mar. 1, 2012

(54) RESERVATION AND TICKETING PROCESS FOR SPACE-AVAILABLE SEATS TO AIRLINE EMPLOYEES

(75) Inventor: Tristan Schukraft, West Hills, CA (US)

(73) Assignee: NON-REVENUE HOLDINGS, LLC, Beverly Hills, CA (US)

(21) Appl. No.: 13/274,846

(22) Filed: Oct. 17, 2011

Related U.S. Application Data
(63) Continuation-in-part of application No. 11/672,426, filed on Feb. 7, 2007.

(51) Int. Cl. G06Q 10/02

(52) U.S. Cl. 705/5

(57) ABSTRACT

The process for reserving and ticketing space-available seats to an airline employee affiliate associated with an employing airline for travel on a transporting airline includes providing a common information platform containing flight information for non-revenue interline travel. An interline travel parameter is established governing flight itinerary options for the airline employee affiliate. The airline employee affiliate obtains a travel authorization associated with the interline travel parameter in order to obtain an interline travel itinerary. Electronic ticket data is then associated with the interline travel itinerary and transmitted to the transporting airline reservation system to complete reservation and ticketing.

### BACKGROUND OF THE INVENTION

The present invention relates to airline reservation and ticketing processes. More particularly, the present invention relates to reservation and ticketing of space-available and positive-space seating to airline employee affiliates.

Since the first days of commercial airline flight, airline carriers have been burdened with the job of making reservations and writing or printing out passenger tickets on paper. In recent years, the reservation and ticketing process for commercial airline passengers developed electronically. A prospective airline passenger desiring to book a seat on an aircraft may go through either a travel agent or the airline carrier. The travel agent or airline carrier searches an electronic reservation and ticketing system administered by the transporting airline to ascertain seat availability and costs for the desired date, time, and flight destination. Once informed that a seat is available for the desired date, time, and destination, the prospective airline passenger then selects a seat and pays for the fare. The travel agent or airline carrier then issues either a paper ticket or an electronic ticket. To obtain a boarding pass, the traveler's paper ticket is provided to an airline agent or if the traveler has an electronic ticket, the traveler could utilize a self-service kiosk by entering their electronic ticket number and/or PNR/Record locator. If the airline passenger does not check-in for the flight or is not present at time of departure (e.g., a no-show), the seat assigned to that airline passenger becomes available for use by standby passengers. Standby passengers are prospective airline passengers who pay for a standby ticket and wait at the airline gate for a seat on a less than fully booked flight or for a seat that opens up on a fully booked flight because other passengers fail to check-in or miss their flight for various reasons.

Computerized reservation and ticketing systems for transportation services generally have real-time information concerning capacity, routes served, schedules for those routes, and pricing information. These systems perform a variety of functions including managing capacity, quoting prices to potential service users, administering retail passenger reservations requests, collecting payments, tracking service delivery, and reconciling any issues after the service is delivered.

The reservation and ticketing system briefly described above is only one example of a computerized retail reservation system. Retail reservation systems range from simple web-based applications to large complex mainframe computer systems like SABRE. The airlines use large complex mainframe systems to integrate and consolidate all the operations of passenger travel into one system. Hence, all major airlines can provide consolidated airline travel through these computerized reservation and ticketing systems. The main goal of an airline reservation and ticketing system is to generate optimum revenue from a fixed set of routes, by maximizing the number of passengers traveling per flight between destinations. Even with the use of such an advanced reservation and ticketing system, airline seats are still available despite the availability of standby passengers ready to fly.

Nonrev generally refers to passengers on commercial airline flights that do not produce revenue for the transporting airline during travel. The term “nonrev” is an abbreviation used by airlines to designate “non-revenue”. Most nonrev airline passengers are employees of an airline. Airline employees, including airline employee family members, travel agents, affiliate company employees, and anyone eligible to receive airline transportation benefits are herein collectively referred to as “airline employee affiliates”. Airline employee affiliates also fall into the category of nonrev passengers. Airline employee affiliates also typically receive free or reduced rate travel as an employment benefit through direct employment with a transporting airline or as an indirect benefit via a relationship with someone who is employed by a transporting airline. Airline travel benefits are a valuable part of an employee compensation package. Interline travel, also known as offline travel, allows airline employee affiliates to travel at a fraction of the cost relative to non-travel industry related airline passengers. Interline travel also includes travel by airline employee affiliates on a transporting airline other than the affiliated employing airline.

There are currently four predominant methods of calculating interline travel fare costs for airline employee affiliates: (1) Zonal Employee Discount (ZED); (2) Interline Discount (ID); (3) Service Charges (SVC); and (4) flat fares. ZED was formed in 1994 to simplify travel arrangements and costs for airline employees traveling on airline carriers other than the employing airline. ZED is an association of over 140 participating airlines. Most, but not all, interline travel agreements are reciprocal agreements between the transporting airline and employing airline. These contracts are often called “bilateral agreements”. Airline agreements may also vary with respect to embargos and restrictions on code shares.

Prior to ZED, airlines primarily calculated interline travel fares based on the ID System (e.g., ID90, ID50, etc.). ID ticket prices are based on a percentage discount off the published full fare price corresponding to the same origin and destination. For example, the ID90 fare discount is 90% off the most expensive economy fare (also called a “Y” fare). The airline employee pays 10% of the published “Y” fare. All participating airlines are subject to the same ID90 rules. A similar set of rules applies to the other ID systems (ID75, ID50, etc.) Under the ID50 system, an airline employee can usually place a firm airline seat reservation, but will be the first bumped from the flight in the event of overbooking.

ZED created travel zones with specific fare prices to better facilitate the predictability of fares and to ease interline travel planning and ticketing. ZED uses mileage to determine the fare for non-revenue, space-available and positive space travel. ZED does not use a percentage of a published fare, like the ID System. ZED currently breaks interline travel into nine zones within the range of 1-9,000 miles (i.e., Zone 1=1 to 450 miles, Zone 2=451 to 750 miles, Zone 3=751 to 1,600 miles, Zone 4=1,601 to 3,200 miles, Zone 5=3,201 to 4,080 miles, Zone 6=4,081 to 5,000 miles, Zone 7=5,001 to 6,100 miles, Zone 8=6,101 to 7,100 miles, and Zone 9=7,101 to 9,000 miles). ZED also includes three fare levels within the nine mileage zones: ZED High (ZH), ZED Medium (ZM), and ZED Low (ZL). Bilateral agreements for interline travel within the ZED framework may vary. One such variation includes calculating interline travel fares based on the three fare levels described above. The bilateral agreements in ZED may also impose reciprocal restrictions on employee affiliates, routes, and ticket quantities. The ZED system is extensive and does not depend only on airline alliances. Different airlines from different airline alliances may join ZED.

In other agreements, airlines sell “over the counter” standby tickets to employees of other airline carriers. These airlines can charge a predetermined, nominal SVC for transportation or calculate airfare under ZED, ID, or other fare rules. In yet other agreements, transporting airlines charge airline employee affiliates a flat fare for interline travel. For flat fares, the interline ticket cost does not fluctuate. Regardless of the city of origin, destination, distance, or date and time of the flight, the cost is constant.

To fly interline, some transporting airlines only require an airline employee ID card before allowing the airline employee affiliate to purchase interline travel. But, other transporting airline may require a request letter from the employing airline. Such a request for interline travel may or may not be granted by the transporting airline. Individual interline travel requests are particularly cumbersome when there is no previous agreement between the employing airline and the transporting airline.

Interline travel for airline employee affiliates is further complicated because the reservation and ticketing systems of individual airlines are unable to communicate with one another. Airline employee affiliates are unable to go back to a common kiosk, website or reservation system to change itineraries due to overbooking, missed flights, etc. The airline employee affiliate must deal with both the employing airline and transporting airline to obtain ticket refunds for flights not flown. Furthermore, portability of interline tickets is hindered as airline carriers tend to have multiple interline travel agreements. The terms of each agreement depends on a number of factors including the airline. For example, an airline employee purchases an interline ticket under the ZED fare rules. If the airline employee then decides that travel with that particular ticket is not possible, the interline ticket is not necessarily transferable to a different transporting airline. In some cases traditional paper tickets are transferable, but not e-tickets or ticketless reservations. Portability depends on the bilateral agreement between the transporting airline and the employing airline. If the employing airline has an agreement with the new transporting airline specifying ID90 fare rules, the airline employee must purchase a second ticket and seek a refund for the first ticket.

Additionally, arranging interline travel is a cumbersome process for airline employee affiliates endeavoring to travel on transporting airlines other than the employing airline. Currently, there is little or no coordination between the computer reservation and ticketing systems of the various airline carriers. Further, some airline carriers do not maintain electronic reservation and scheduling systems. Buying and maintaining such a system can be cost prohibitive, especially for a small airline carrier with limited funds.

The International Air Transport Association (IATA) mandates that all airline ticketing must be by e-ticket by Apr. 1, 2012. As a result, transporting airlines must develop individual direct e-ticketing connections among affiliated airlines, connect to an interline e-ticketing “HUB” such as the process of the present invention, or be prepared to revoke the interline travel benefits from the airline employee affiliates. To build a direct connection for each interline agreement, the airlines will be required to modify existing reservation and ticketing systems to be compatible with other airline reservation and ticketing systems. Compatibility among multiple transporting airlines is cost prohibitive. There are enormous administrative and cost implementation issues, which include issuing tickets on behalf of the interline employee, employment verification for airline employee affiliates, and little or no flexibility for last minute changes to an interline travel itinerary. Furthermore, the transporting airline absorbs merchant fees and other e-ticketing costs. These fees will tend to be higher for larger airlines that issue far more interline tickets than smaller airlines. Transporting airlines must administer interline travel ticket refund requests, the employing airline must administer certain interline travel ticket refund disputes, and airline employee affiliates will experience limited payment options and must deal with multiple refund policies. Ultimately airlines without electronic reservation systems cannot participate.

In one example, if the transporting airline were to provide e-ticket fulfillment, the transporting airline would absorb the cost of merchant fees and other related fees. Large airlines like Delta, British Airways, or Cathay Pacific would spend millions annually. Specifically, a ZED Medium fare from LAX to NB costs $10.81 USD in merchant fees alone. To further complicate matters, airline employee affiliates often request backup itineraries that are not used. The transporting airline absorbs the costs associated with these backup itineraries as well. Without interchangeability of an interline e-ticket connection through a common database or system, airline employees are forced to buy these backup itineraries and then go through the process of requesting multiple refunds when those backup itineraries go unused.

Accordingly, there is a need for a process that interconnects airline carrier computer reservation and ticketing systems in a format that is user friendly for interline travelers. There is a further need for a process that interconnects airline carrier computer reservation and ticketing systems to facilitate cost effective e-ticketing and interline travel. The present invention fulfills these needs and provides other related advantages.

### SUMMARY OF THE INVENTION

The process for reserving and ticketing space-available seats to an airline employee affiliate associated with an employing airline for travel on a transporting airline includes providing a common information platform containing flight information and airline employee affiliate information for reserving and ticketing non-revenue interline travel. An interline travel parameter established in the common information database governs the reservation and ticketing options for the airline employee affiliate for travel on the transporting airline. As part of this process, a contract provision may be added to the common information platform that defines multiple interline travel parameters between the employing airline and the transporting airline. These interline travel parameters limit the scope of a travel authorization issued by the employing airline for non-revenue airline travel on the transporting airline. The interline travel parameter may include departure day or time, arrival day or time, flight duration, seating priority, seat assignment, connection quantity, or seat availability.

The common information platform processes the travel authorization issued by the employing airline and associates it with the interline travel parameter. This permits facilitating self-ticketing of the airline employee affiliate with the travel authorization through the common information platform. Accordingly, the facilitating step typically occurs without contacting the transporting airline. The common information platform may process the travel authorization from a representative of the employing airline or directly from the airline employee affiliate through interaction with the common information platform. After the travel authorization is provided to the common information platform, the common information platform retrieves transporting airline fares within the scope of the interline travel parameter using an airline fare calculator accessible through the common information platform database. Of course, the common information platform verifies the eligibility of the airline employee affiliate before granting the airline employee affiliate access to the common information platform. Once verified, the airline employee affiliate may reserve a ticket for non-revenue interline travel with the travel authorization. The common information platform may verify eligibility by retrieving access information from an employer database or from a database in the common information platform.

The common information platform then tickets the airline employee affiliate with an airline travel itinerary on the transporting airline within the scope of the interline travel parameter. The interline travel parameter may include a space-available or a positive-space available seating option on the transporting airline. In a preferred embodiment, the space-available or the positive-space available seating option includes a first class ticket. The common information platform then associates electronic ticket data with the interline travel itinerary and transmits the electronic ticket data and the interline travel itinerary to the transporting airline reservation system. In the event of a flight restriction or a weather advisory, the common information platform notifies the airline employee via electronic message. Furthermore, the common information platform may provide the airline employee affiliate with a revised reservation and ticketing option based on a transporting airline load factor or a stand-by list. As a result, the common information platform endeavors to provide ticketing and reservation information to the airline employee affiliate on the next space-available or positive-space available seating option that best accomplishes the original interline travel itinerary selected by the airline employee affiliate.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings.

FIG. 1 is a flowchart that illustrates the overall reservation and ticket process of the present invention;

FIG. 2 is a flowchart that illustrates a listing process of the present invention;

FIG. 3 is a flowchart that illustrates a process for travel fulfillment by a third party purchase facilitator;

FIG. 4 is a flowchart that illustrates a process for travel fulfillment by an employing airline;

FIG. 5 is a flowchart that illustrates a process for travel fulfillment by the transporting airline;

FIG. 6 is an alternative illustration of the flowchart of FIG. 4;

FIG. 7 is an alternative illustration of the flowchart of FIG. 5, illustrating manual paperless e-ticketing by the transporting airline;

FIG. 8 is an alternative illustration of the flowchart of FIG. 5, illustrating automated paperless e-ticketing by the transporting airline;

FIG. 9 is a flowchart illustrating the process and communication of the interline fare calculator; and

FIG. 10 is a flowchart illustrating the process of self-ticketing an airline employee affiliate without contacting the transporting airline.

### DETAILED DESCRIPTION OF THE PREFERRED EMBODIMENTS

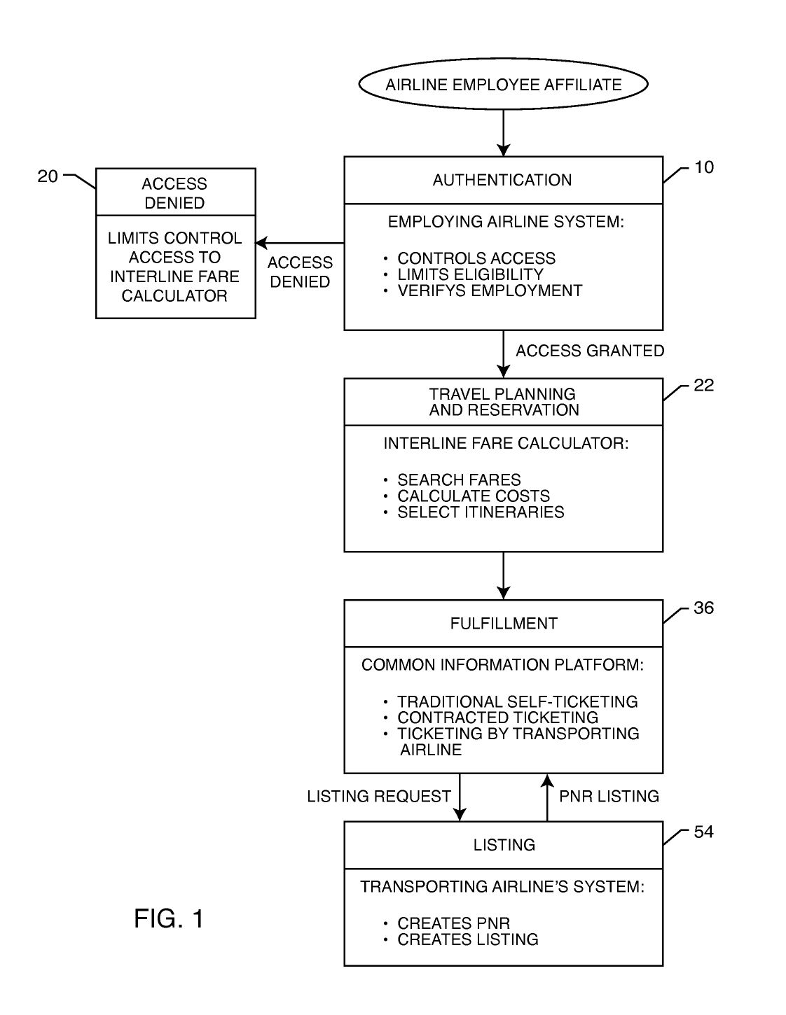

As shown in FIGS. 1-10 for purposes of illustration, the present invention discloses a process for reserving and ticketing positive-space or space-available seating for airline employee affiliates. In accordance with an embodiment of the present invention, a company acts as a third party “purchase facilitator” to collect funds, issue e-tickets, and manage travel reservations for interline travel by airline employee affiliates. The third party purchase facilitator or other service providers provide an unbiased web-based platform which interconnects multiple airline computer reservation systems, Global Distribution Systems (GDS), or other service providers in a secure environment. The third party purchase facilitator will also provide web-based access to employees of airlines that do not offer electronic ticketing. In turn, airline employers can provide a cost effective electronic interline travel reservation system that protects the airline travel privileges of airline employee affiliates. The third party purchase facilitator charges the airline employee affiliate or employing airline a nominal transaction fee to cover maintenance costs, system improvements, credit card transaction costs, and other related fees.

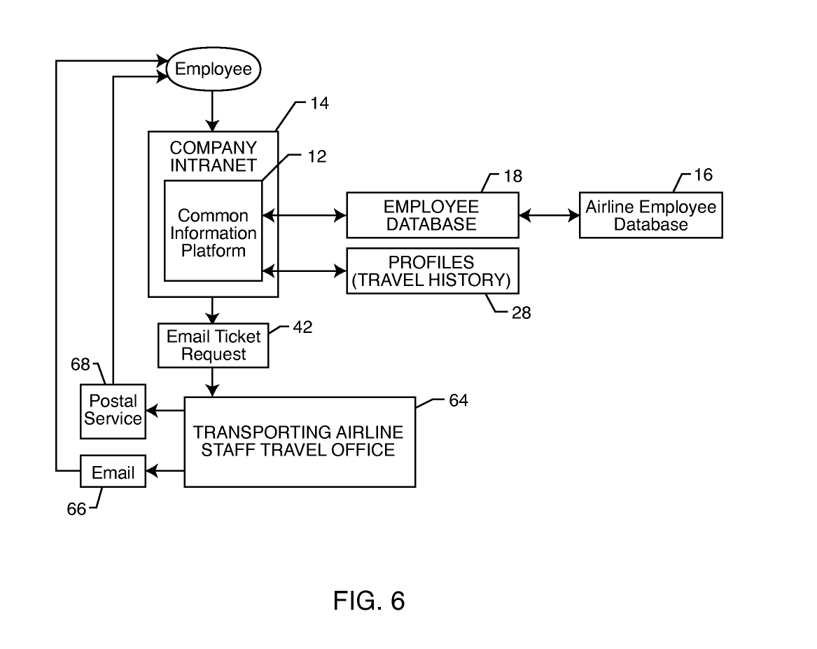

FIG. 1 is a representative flowchart that illustrates the overall reservation and ticketing process of the present invention. The first step in the process for reserving and ticketing positive space and/or space-available seating for airline employee affiliates is an authentication stage 10. The airline employee affiliate must first log into a third party purchase facilitator web-based common information platform 12 (FIGS. 6-8). Access to the common information platform 12 is provided electronically through the Internet, an employing airline intranet 14 (FIGS. 6-8), a kiosk, cell phone, personal digital assistant (PDA), or other electronic device known in the art that provides access to an electronic database. Access through a secure web site is particularly conducive for airline employee affiliates of employing airlines that do not have an established intranet or electronic reservation system. The third party purchase facilitator controls employee access, limits eligibility, and verifies employment during the authentication stage 10. The third party purchase facilitator requires employment verification of the airline employee affiliate before granting access to the common information platform 12. It is preferred that employment is verified by accessing a Lightweight Directory Access Protocol (LDAP), a ZED card, an intranet authentication protocol, or other non-intrusive validation protocols directly linked to the airline employee database 16 (FIGS. 6-8). But, other web-based validation methods known in the art may also be used. An employee database 18 (FIGS. 6-8) hosted by a third party or the common information platform 12 may be used.

An eligibility authenticator limits control access to the common information platform 12 during the authentication stage 10. The eligibility authenticator communicates information in an encrypted form along a Secure Socket Layer (SSL). SSL works by using a private key to encrypt data that is transferred over the SSL connection. Encrypted words and script inhibitors prevent unauthorized access to the common information platform 12.

The authentication stage 10 validates the airline employee affiliate to ensure that the user logging into the common information platform 12 is an airline employee affiliate. The eligibility authenticator asks the airline employee affiliate a series of questions to determine employment status and interline travel eligibility. Information required during the validation process may include, username, password, name, employee number, Social Security number, date of birth, or date of hire. The answers inputted by the airline employee affiliate are transferred to the airline employee database 16 through the Human Resources (HR) department or the employee database 18 via either the LDAP or an XML transfer protocol. LDAP has access to directories that retain information such as employee records, customer preferences, patient information, student records, and public records. LDAP is a protocol that enables interoperation of multiple databases. The system may be compatible with both LDAP and XML depending on which protocol the employing airline uses. The transfer protocol system (i.e., LDAP or XML) only exchanges information between the common information platform 12 and the information stored on another database, such as the airline employee database 16 of the employing airline HR department.

After the information inputted by the airline employee affiliate is cross-referenced using the LDAP or XML protocol, the eligibility authenticator returns either a value of “TRUE”, if the information provided by the airline employee affiliate is correct, or returns a value of “FALSE”, if any portion of the information provided by the airline employee affiliate is incorrect. The airline employee affiliate is denied access to the common information platform 12 when the eligibility authenticator returns a value of “FALSE”. The airline employee affiliate is moved to a denied access stage 20 that limits control access to the common information platform 12. Absent authentication, the airline employee affiliate is unable to use the interline fare calculator to research interline travel flight benefits. Additionally, steps concerning travel, reservation, and ticketing are unavailable.

Airline employee affiliates may also access the interline fare calculator in the common information platform 12 as a stand-alone research tool. In this embodiment, the airline employee affiliate uses a generic username and password issued by the employing airline for use with all its airline employee affiliates. Airline employee affiliates are able to create an interline travel itinerary, but ultimately need to request approval from the employing airline, since the airline employee affiliate is not personally identified upon login to the common information platform 12. E-ticket issuance is also administered by the employing airline. But, this process is not as efficient and cost effective for the employing airline as individual airline employee affiliate account profiles stored in the common information platform 12. In this embodiment, the common information platform 12 would not validate the airline employee affiliate via LDAP or XML.

By utilizing LDAP or XML, airlines are able to accurately validate employee employment and eligibility online and in real-time. As a result, there is no need for an employing airline issued reader card and corresponding middle-ware solution, which only adds costs associated with administrative time. Although, such a reader card and middle-ware solution could be integrated with the system described herein. Information transferred to the third party purchase facilitator during the authentication stage 10 may or may not be retained in the common information platform 12.

In an alternative embodiment, the common information platform 12 can directly connect, in a secure environment, to the airline employee database 16 of the employing airline HR department. The airline employee affiliate similarly responds to a number of validation questions. The inputted answers are verified by connecting directly to and accessing information stored in the airline employee database 16. Input information might include the names of eligible travelers and relationships, e-mail addresses, an employment or employee number, date of employment, credit card information, addresses, or contact numbers. The common information platform 12 communicates with the airline employee database 16 to verify the accuracy of the answers. Before granting access to the common information platform 12, the eligibility authenticator requires a “TRUE” response. Interline eligibility and other required information is processed at this point. The airline employee affiliate is then able to proceed to a travel planning and reservation stage 22.

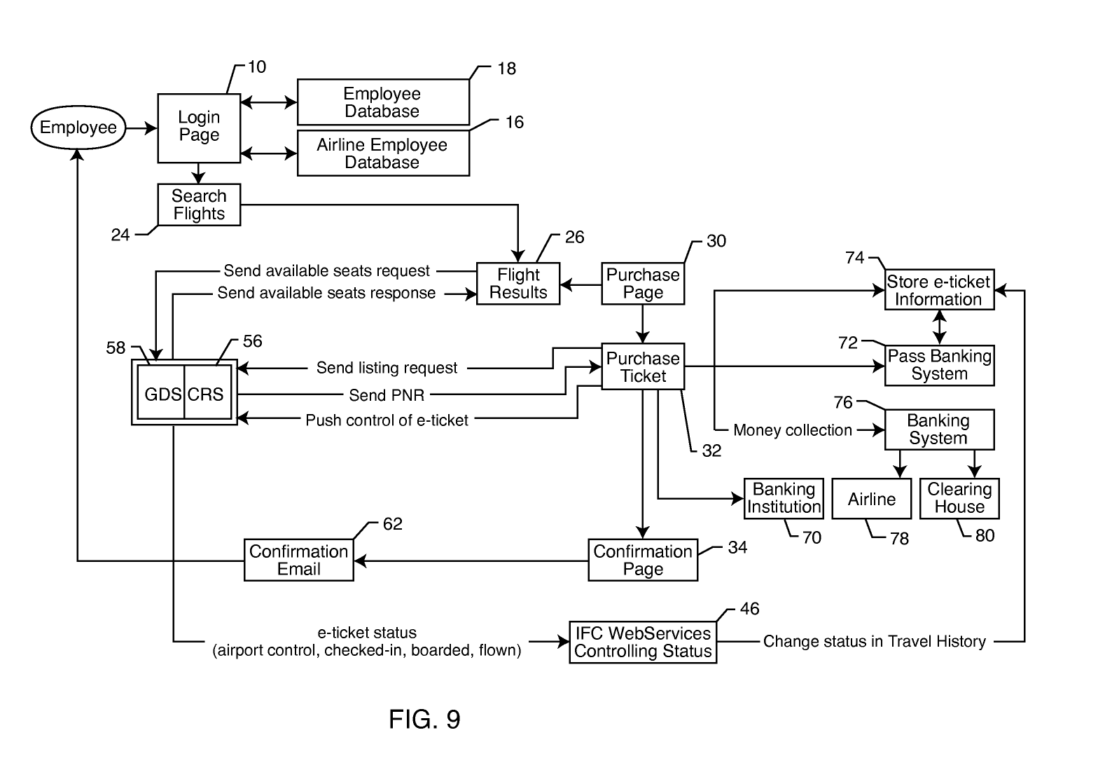

Access to the common information platform 12 travel and reservation planning is granted when the third party purchase facilitator verifies the correct responses via the eligibility authenticator. Once access is granted, the airline employee affiliate enters the travel planning and reservation stage 22. Here, the airline employee affiliate has access to an interline fare calculator, such as the ZED Fare Calculator™, for searching fares, calculating costs, and storing itineraries. The airline employee affiliate searches for fares during a flight search stage 24 (FIG. 9) based on eligibility and flight schedules published by the employing airline and other transporting airlines via public resource. Fare searches may include a number of different criteria including, but not limited to, flight costs, date, availability, origin, and destination. Preferably, any and all information associated with flight travel is searchable. A search result stage 26 (FIG. 9) is also sortable according to the above-mentioned criteria.

The interline fare calculator also calculates the entire interline travel cost. This calculation includes taxes, charges, and fees—including airport fees, security fees, and governmental fees applicable to non-revenue interline travel—in addition to the interline travel fare. Taxes are calculated based on information provided by IATA. To calculate the total cost of the travel itinerary, the interline fare calculator verifies the tax rules, type of flight, passenger categories, class of service and if the passenger is transiting. Since all this information is compiled within the database of the common information platform 12, the interline fare calculator is capable of providing a fast and accurate interline travel itinerary cost.

More specifically, the interline fare calculator is the end user interface for airline employee affiliates to research interline flight benefits. The fare calculator is used as a stand-alone research tool (with or without employment verification) or in conjunction with the common information platform 12 where airline employee affiliates may request e-tickets, make space-available listings, and make last minute itinerary changes. The common information platform 12 maintains all information utilizing the latest IATA and The Official Airline Guide (OAG) resources so that all information communicated to the airline employee affiliate is accurate and up-to-date. Such information includes schedule updates, weather advisories, travel restrictions, embargoes, fare and agreement changes, and taxes, fees, and charges. Furthermore, during the search result stage 26 the interline fare calculator is customizable and can return the search results based on: departure day and time, arrival day and time, date, flight type registry, flight combinations, flight stops, airline contracts, and miles (distances). Other features of the interline fare calculator include the capability to verify taxes, save search data, calculate taxes, fees, and charges for each leg of a round-trip ticket, verify eligible flights, mark non-eligible flights, and return search results.

Once the airline employee affiliate settles on the desired travel route and expense, the airline employee affiliate may store the itinerary in electronic form in the common information platform 12 as administered by the third party purchase facilitator. The airline employee affiliate may store multiple alternate itineraries within the common information platform 12 if, for example, the airline employee affiliate is unsure whether that original itinerary is conducive to traveling. The common information platform 12 contains all flight information, airline employee affiliate profiles 28 (FIGS. 6-8), and relevant information required for interline travel.

The common information platform 12 can also store custom accounts in the profiles 28 concerning individual airline employee affiliates. Here, the airline employee affiliate has access to future flights, flight history, payment method information, ticket requests, and ticket cancellations or refunds. Any communication with a remote directory that stores airline employee affiliate information is through the LDAP or XML protocol with SSL encrypting, as previously discussed. Furthermore, the profiles 28 stored in the common information platform 12 may include information concerning flight status, dependent status, eligibility, or inactive or suspended employment of eligibility benefits. The common information platform 12 may also store statistical information with regard to certain profiles 28 including search history, itinerary requests, past requests, aggregate tickets requested during a searchable time frame, number of segments flown during a specified time frame, most requested airline, or most requested destination. Additionally, transporting and employing airline administrators may search these statistical categories based on individual employees, groups of employees, or all airline employee affiliates with access to interline travel benefits.

As generally shown in FIG. 9, the airline employee affiliate is then presented with a purchase page 30 where a ticket 32 is purchased. Accordingly, a confirmation page 34 summarizes all relevant travel itinerary information including costs.

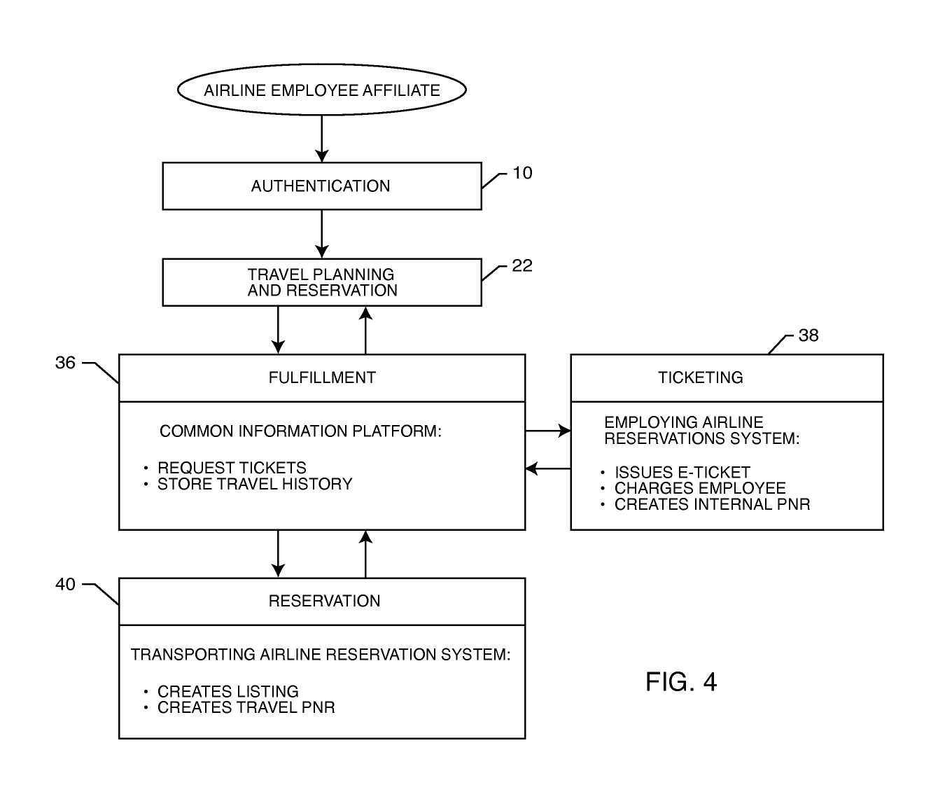

Specifically, a fulfillment stage 36 follows the travel planning and reservation stage 22 once the airline employee affiliate chooses an interline travel itinerary. The fulfillment stage 36 includes a variety of ticketing options including traditional self-ticketing, contracted ticketing, and ticketing by the transporting airline. For traditional self-ticketing, as illustrated in FIG. 4, the fulfillment stage 36 includes having the third party purchase facilitator communicate the travel itinerary selected by the airline employee affiliate to the employing or transporting airline reservation system. During a ticketing stage 38, under traditional ticketing, the employing airline issues an e-ticket, creates an internal Personal Name Record (PNR/record locator), and collects the funds directly from the airline employee affiliate. The e-ticket data is then transmitted electronically from the employing airline reservation system back to the common information platform 12. The common information platform 12 associates the e-ticket with the travel itinerary of the airline employee affiliate. The e-ticket and travel itinerary is then communicated in electronic form to the transporting airline reservation system for a reservation stage 40. An e-mail ticket request 42, shown in FIG. 6, is only one way to electronically communicate the e-ticket and travel itinerary. The transporting airline thereafter creates the listing and travel PNR/record locator. The transporting airline transmits the listing and PNR/record locator information back to the common information platform 12 for association and storage with the e-ticket and travel itinerary. The airline employee affiliate is now listed for standby travel with the transporting airline. Since all the information generated by the employing airline and the transporting airline is stored on the common information platform 12, the airline employee affiliate has easy access to any information regarding the interline travel itinerary.

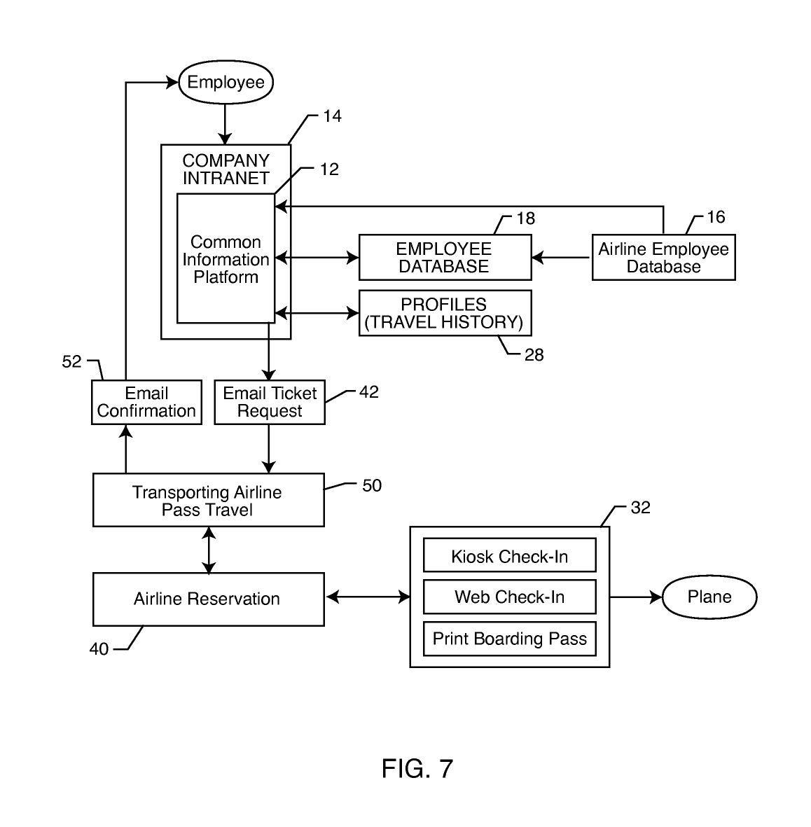

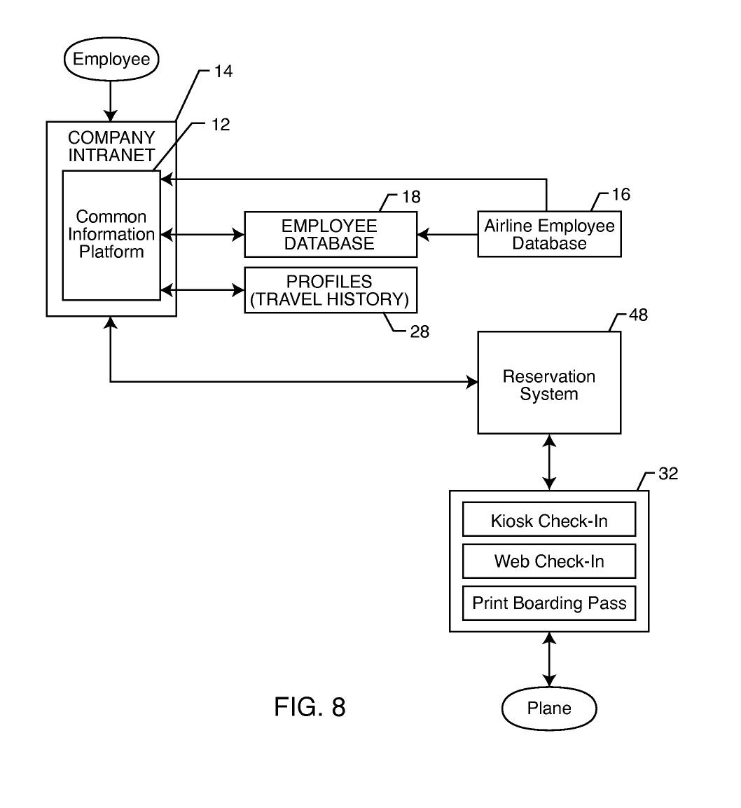

The common information platform 12 is a Universal Electronic Ticketing Platform (UETP). An airline employee affiliate need only make one connection with the common information platform 12 to interline with any participating transporting airline, including the employing airline. The common information platform 12 is able to “translate” any electronic information in and among participating transportation airline reservation systems, HR databases, etc. Special protocols within the common information platform 12 enables intercommunication among all participating transportation airlines. The common information platform 12 is designed to “push” and “pull” information among airline reservation systems in formats automatically compatible with said systems. This inter-connectivity allows airline employee affiliates to take advantage of a set of transporting airline travel tools 44 (FIGS. 7-8), such as online check-in, web check-in, and print boarding pass, because the common information platform 12 is directly connected to each transporting airline reservation system. The UETP is advantageous over the current system because each individual transporting airline does not need to make a direct interline connection with every individual transporting airline. This is particularly useful in that the transporting airline and/or employing airline does not need to create a new reservation system or create a protocol to translate information for automatic reception by either reservation system. In most cases, the transporting airline or employing airline would need to modify a protocol or the reservation system itself to communicate with one another. The common information platform 12 addresses all of these initial communication problems and any changes within the reservation systems of the transporting airline, or employing airline to keep the system up-to-date and interconnected.

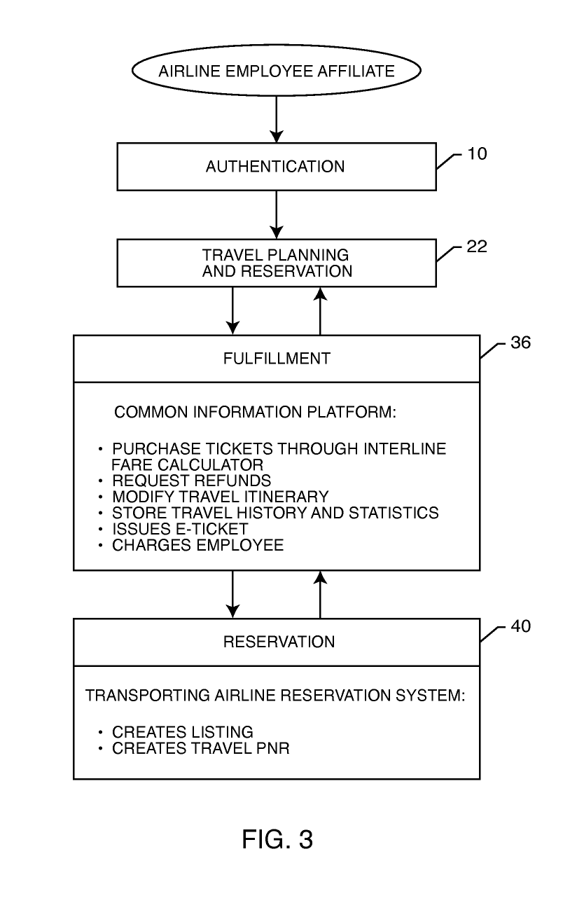

In an alternative embodiment of the present invention, the fulfillment stage 36 is accomplished through contracted ticketing with the third party purchase facilitator as illustrated in FIG. 3. Under contracted ticketing, the third party purchase facilitator is authorized to issue an e-ticket on behalf of the transporting airline via the common information platform 12. The third party purchase facilitator also charges the airline employee affiliate directly. Essentially, the third party purchase facilitator operating the common information platform 12 acts as the validating airline. An interline fare calculator web service 46 manages complete “control” of the e-ticket. In terms of changing itineraries or requesting refunds, the employing airline and transporting airline are not involved. The third party purchase facilitator eliminates any steps requiring the transporting airline or the employing airline to deal directly with the airline employee affiliate. Eliminating these steps saves the transporting airline and the employing airline the costs associated with processing and refunding tickets. Via the common information platform 12, the airline employee affiliate can also cancel, reroute, or modify the interline travel itinerary, or even change transporting airlines online. The airline employee affiliate must pay for any additional fees as required under the terms of the bilateral agreement between the employing airline and the transporting airline. Refunds or credits for less expensive interline travel is returned directly to the airline employee affiliate.

Modification of the interline travel itinerary by the airline employee affiliate is accomplished in a number of different ways including a web-based program, cell phone, PDA, or other electronic communications device. This is particularly useful as the airline employee affiliate is able to quickly switch to an alternative itinerary in case the airline employee affiliate must cancel the original itinerary, for whatever reason. Once the airline employee affiliate changes the interline travel itinerary, a new PNR/record locator is created by the new transporting airline for use with the alternative itinerary. The common information platform 12 then cancels the original itinerary with the original transporting airline and processes the alternate itinerary with the alternative transporting airline. For example, the common information platform 12 sends e-ticket information to the original transporting airline. When the airline employee affiliate decides to change the original itinerary, the common information platform 12 “pulls” control of the e-ticket from the original transporting airline (refunds) and “pushes” a new e-ticket (issues), corresponding to the transporting airline and transmits back a new PNR/record locator to the common information platform for use with the alternative itinerary, to the second transporting airline. The common information platform 12 automatically streamlines the process of canceling the e-ticket with the first transporting airline and issuing a new ticket and listing the airline employee affiliate with the second transporting airline. All of these changes are done automatically and electronically through the common information platform 12 and corresponding protocols that enable intercommunication among the multiple transporting airline reservation systems.

Furthermore, under contracted ticketing the third party purchase facilitator is authorized to issue an e-ticket on the “stock” (i.e., the billing code used by a transporting airline to issue a paper ticket) of the transporting airline. The stock issued by the third party facilitator can use the billing code of a transporting airline or establish an internal billing code unique to the third party purchase facilitator. The third party purchase facilitator can then use either the billing code of the transporting airline or the unique internal billing code to settle purchases through a clearing house. The detailed billing process is disclosed in further detail later in the specification. The third party purchase facilitator may issue a paper ticket or an electronic authorization if the transporting airline does not offer e-ticketing.

While the airline employee affiliate is in communication with the common information platform 12 during contracted ticketing, the common information platform 12 is also in communication with the reservation system of the transporting airline. During a reservation stage 40, electronic travel itinerary data, including the e-ticket, is communicated to the transporting airline in a format automatically compatible with the transporting airline reservation system. The transporting airline uses the electronic travel itinerary data to create a listing and a PNR/record locator for the airline employee affiliate. The listing information and PNR/record locator is then communicated back to the common information platform 12 in electronic form. The common information platform 12 receives the listing and PNR/record locator information from the transporting airline and associates this information with the electronic travel itinerary and e-ticket information. The information is stored in the common information platform 12 wherein the airline employee affiliate may access the reservation information from any one of the access points as previously discussed. The airline employee affiliate may view, change, or cancel the itinerary at any time via the common information platform 12. The common information platform 12 automatically communicates any changes to the travel itinerary to the transporting airline.

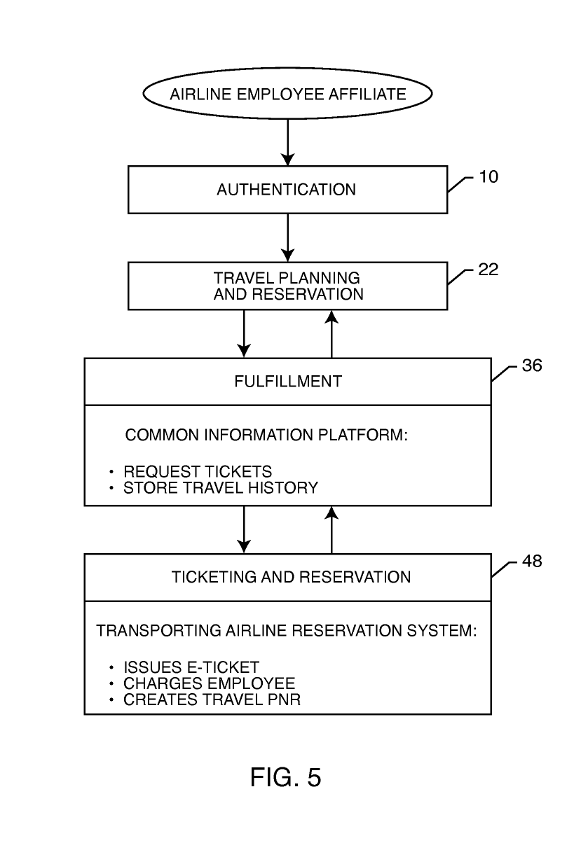

In yet another alternative approach to the fulfillment stage 36, ticketing is conducted directly by the transporting airline. As shown in the flowcharts of FIGS. 5, 7 and 8, the airline employee affiliate can search flights, calculate fares, and create a travel itinerary, as previously discussed, in the travel planning and reservation stage 22. During the fulfillment stage 36, under ticketing by the transporting airline, the common information platform 12 translates the relevant travel itinerary information in electronic form to the transporting airline reservation system. The electronic itinerary information is sent in a format compatible with the transporting airline reservation system. For manual paperless e-ticketing, the e-mail ticket request 42 will suffice to convey the ticket request in a format compatible with the transporting airline reservation system. Although, any other form of electronic communication known in the art will also suffice.

After receiving the itinerary information in electronic form, the transporting airline reservation system issues an e-ticket, paper ticket, paperless ticket, ticketless travel, or other authorization or ticketing, charges the airline employee affiliate directly, and creates a listing and PNR/record locator for the airline passenger during a ticketing and reservation stage 48. The travel information created by the transporting airline is then communicated back to the common information platform 12 for association and storage with the travel itinerary information. Again, the airline employee affiliate has around-the-clock access to all itinerary and travel information via the common information platform 12, through any of the access points as previously discussed. For manual paperless e-ticketing in FIG. 7, a transporting airline passenger travel database 50 sends an e-mail confirmation 52 to the airline employee affiliate while in communication with the transporting airline reservation system during the reservation stage 40.

Information stored by the common information platform 12 is dynamic. This means that the common information platform 12 automatically communicates relevant travel itinerary information among and between employing airlines and transporting airlines. The common information platform 12 sorts, formats, and transmits electronic data in a format automatically compatible with any reservation system via a set of conversion protocols specific to the reservation system of each airline carrier. These protocols within the common information platform 12 provide greater flexibility and enforcement of the fare restriction rules set forth in each bilateral agreement. Additionally, the common information platform 12 sends only relevant information required by either the transporting airline or the employing airline to successfully administer interline travel. Hence, the information stored by the common information platform 12 is dynamic—i.e., the information and format changes with each individual airline carrier.

To this point, the reservation and ticketing process for space-available or positive-space seats for airline employee affiliates is facilitated by first validating the employment status of an airline employee affiliate desiring to travel interline. Answers to a series of questions as inputted by the airline employee affiliate are compared with data stored in a HR database of the employing airline affiliate. Once validated, the airline employee affiliate is granted access to an interline fare calculator, such as the ZED Fare Calculator™, which is associated with the common information platform 12 reservation and ticketing system. Through the common information platform 12, the airline employee affiliate can search flights, calculate fares, request tickets, store current travel itineraries, and examine past travel itineraries. Once the airline employee affiliate chooses an itinerary and moves to the fulfillment stage 36, the common information platform 12 processes the travel itinerary request under any one of three ticketing solutions: (1) traditional self ticketing by the employing airline; (2) contracted ticketing by the third party purchase facilitator; or (3) ticketing by the transporting airline.

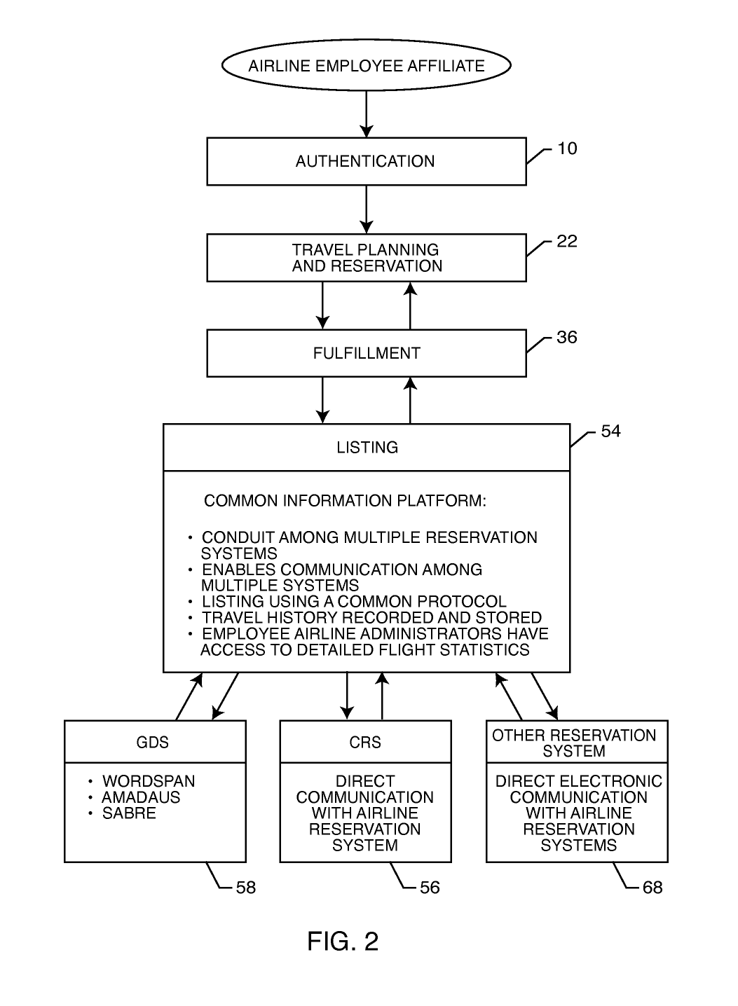

The next step in the travel reservation and ticketing process is a listing stage 54, which is illustrated in the flowchart of FIG. 2. FIG. 2 briefly illustrates the stages of reserving space-available seats to airline employee affiliates leading up to the listing stage 54. The airline employee affiliate is verified during the authentication stage 10, selects an interline travel itinerary during the travel planning and reservation stage 22, and receives relevant e-ticket information during any of the three types of fulfillment stages 36. The common information platform 12 automatically makes the interline travel reservation through any one of a number of service provider systems during the listing stage 54. The information communicated to the service provider systems is dynamically formatted for automatic reception. The PNR/record locator is the basic form of computerized airline travel record. A few airlines host independent reservation systems or have direct access to a Central Reservation System (CRS) 56 within a virtual “partition” in a Global Distribution System (GDS) 58. The GDS's are administered by several service providers including WORLDSPAN, AMADAUS, and SABRE. The common information platform 12 enables communication among the multiple service providers, including the GDS's, CRS's, and any other electronic reservation systems 60. The common information platform 12 could also incorporate a global common protocol that requires participating airline reservation systems to be re-designed for compatibility. Although, this system is less efficient than having the common information platform 12 translate relevant travel itinerary and electronic data information among participating airlines because the onerous of compatibility is placed back on the participating airlines. The airline employee affiliate uses the interline fare calculator to communicate with the various service provider systems via the common information platform 12. All required form fields are easily repopulated by the common information platform 12 since the desired travel itinerary and all relevant travel information, including e-ticket and PNR/record locator information, are stored therein. Thus, the listing process does not involve multiple steps for the airline employee affiliate. The airline employee affiliate can cancel or modify any listings online, with the option to view all future travel plans and recent travel history. A common information platform confirmation e-mail 62 (FIG. 9) is always sent to the employee affiliate concerning any changes to the travel itinerary.

In an alternative embodiment, the common information platform 12 communicates directly with the transporting airline website or CRS 56 and completely bypasses the GDS 58. Control of the e-ticket is directly “pushed” (i.e., electronically communicated) to the transporting airline. The transporting airline Departure Control System (DCS), reservation system, or other internal system then retains “control” of the e-ticket through the various stages of travel. The stages of travel communicated back to the common information platform 12 start with the issuance of an e-ticket by the transporting airline.

In the embodiment of FIG. 6, where the employing airline is the transporting airline, a transporting airline staff travel office 64 notifies the airline employee affiliate of the interline travel itinerary and e-ticket via an electronic message (e.g., an e-mail 66) or by a postal service delivery 68. After the airline employee affiliate receives the e-ticket from the transporting airline, the e-ticket is considered open (“O”). The following indicator flight stages include airport assignment (“A”), airport check-in (“C”), boarding (“B”), and lastly the flown status (“F”). If the plane departs and the status of the airline employee affiliate e-ticket does not indicate “flown”, then the e-ticket status indicator moves back to the “open” stage. The DSC, reservation system, or other internal system communicates e-ticket status in electronic form directly to the common information platform 12 during these flight stages. All airline employee affiliate travel history is recorded within the common information platform 12. Employing and transporting airline administrators with access to the common information platform 12 thus have complete control over the detailed airline employee affiliate interline travel statistics. The final indicator of “flown” is the last correspondence between the transporting airline and the common information platform 12 with regard to any individual travel itinerary.

Consider that an airline employee affiliate decides not to fly or misses the flight. The “flown” indicator would not be communicated back to the common information platform 12 of the third party purchase facilitator. The airline employee affiliate could log into the common information platform 12 and request an e-ticket on another flight. The new flight itinerary could use the same transporting airline or a different transporting airline, such as the employing airline. The airline employee affiliate pays for additional fees, taxes, or charges, if any, online and is issued a new e-ticket number and new PNR/record locator for the new itinerary. Control of the e-ticket is pushed to the new transporting airline, or back to the original transporting airline, depending on the new travel itinerary requested by the airline employee affiliate.

For example, an airline employee affiliate purchases an e-ticket for travel from Los Angeles International Airport (LAX) to London Heathrow Airport (LHR) on British Airways. But, the airline employee affiliate is unable to fly because the flight is full, the airline employee affiliate misses the flight, etc. The airline employee affiliate can change the travel itinerary by logging back into the common information platform 12 of the third party purchase facilitator. Say the airline employee affiliate locates the LAX-LHR flight on Virgin Atlantic Airways during the search for a new interline travel itinerary. The common information platform 12 cancels the travel reservation with the original transporting airline, British Airways, and applies credit from the original itinerary to the new itinerary. A new PNR/record locator is created and control of the e-ticket is now with the new transporting airline: Virgin Atlantic. Virgin Atlantic then retains control of the e-ticket through the various stages of travel. The final e-ticket status communicated from Virgin Atlantic to the common information platform 12 is “flown”.

Billing is initiated once interline travel is complete. The billing procedure depends on whether the airline employee affiliate purchased the interline ticket itinerary via (1) traditional self-ticketing by the employing airline; (2) contracted ticketing by the third party purchase facilitator; or (3) ticketing by the transporting airline. In the case of traditional self-ticketing by the employing airline, the airline employee affiliate is billed directly by the employing airline. Cost settlements are then settled between the employing airline and the transporting airline on a periodic basis via a clearing house. Similarly, under ticketing by the transporting airline, the airline employee affiliate is billed directly by the transporting airline. In both the scenarios above, ticket refunds and billing disputes are handled by each individual airline. Hence, the airline employee affiliate must learn the rules and regulations concerning interline airline travel for each individual transporting airline.

Under contracted ticketing through the third party purchase facilitator, the airline employee affiliate has a number of payment and billing options as illustrated in the FIG. 9 flowchart. In one embodiment, an airline employee affiliate banking institution 70 is debited directly by the common information platform 12. In another embodiment, the airline employee affiliate pays for the e-ticket, paper ticket, paperless ticket, ticketless travel, or other travel authorization or ticketing through a passenger banking system 72 such as a credit card or company supported Universal Air Travel Plan (UATP) employee program. UATP is a worldwide corporate travel payment network owned and issued by participating airlines. Each airline employee affiliate would be issued a UATP account number wherein in no card is actually issued or needed. The UATP accounts work similar to credit cards, except that the employing airline would be financially responsible for interline travel expenses incurred by employees. The passenger banking system 72 of each individual airline employee affiliate is associated with a stored e-ticket information 74. Once the status “flown” is returned to the common information platform 12, a common information platform banking system 76 collects the funds for distribution. The common information platform banking system 76 then settles the outstanding bill with either an employing airline banking system 78 or a clearing house 80. Each week UATP bills the employing airline banking system 78, which uses the assigned accounting code for payroll deduction or charges the airline employee affiliate directly via a personal credit card. The airline charging the personal credit card incurs any associated merchant fees. Additionally, the common information platform 12 can utilize the billing code from the transporting airline as a city ticket office (CTO). Billing as a CTO enables the common information platform 12 to handle all billing issues concerning interline travel directly with the transporting airline.

Alternatively, the third party purchase facilitator could use a unique billing code and settle all billing issues through a clearing house 80, or the Billing and Settlement Plan (BSP) set up by the International Air Transport Association (IATA). Here the third party purchase facilitator is acting as another airline.

The web-based common information platform 12 provides an airline employee affiliate with round-the-clock online access to account history, including previous travel itineraries and future travel itineraries. The airline employee affiliate may also directly request travel refunds or travel itinerary changes through the common information platform 12. Since the common information platform 12 has complete control over the reservation and ticketing process, the third party purchase facilitator is able to automatically “push” and “pull” e-tickets between transporting airlines. The common information platform 12 provides maximum flexibility and more “green path” travel reservation opportunities. Additionally, the airlines do not need to buy or develop a reservation and/or ticketing system to be compatible with other airline reservation systems. Thus, there are no development costs for the transporting airlines. The common information platform 12 also reduces settlement disputes between transporting airlines and employing airlines because the third party purchase facilitator automatically and electronically facilitates the terms of the agreements between the participating airlines.

From the standpoint of the employing airline, the common information platform 12 provides complete administrative control over the reservation and ticketing process. The common information platform 12 stores detailed statistics including how employees travel and the most requested transporting airlines. The common information platform 12 provides a stand-alone, maintenance-free interline travel ticketing solution. Hence, employing airlines avoid administrative and financial costs for administering such a system.

Conventionally, most airlines have intranet-based online forms where employees create interline travel itineraries. The intranets are not usually fully and automatically compatible, if in communication at all. The process disclosed herein acts to integrate the separate intranets and corresponding reservation systems by completing and formatting these online forms through a series of conversion protocols. The web-based common information platform 12 used by the third party purchase facilitator “translates” the individual airline form-based information for storage in a format that is compatible with all participating airlines. Airlines can therefore use already developed reservation system technology. Further, the information is dynamic, so the common information platform 12 can deliver the same information in a different format (e.g., date). Hence, the common information platform 12 provides universal compatibility among all participating airlines.

Additionally, the reservation and ticketing system disclosed herein has numerous administrative benefits. Airlines can request bilateral interline travel agreements online. For instance, employing airlines can negotiate with each participating airline individually, or the employing airline can negotiate with all participating airlines at once. Airlines can automatically download approved contracts with no need to modify the agreements once approved. Or, the bilateral agreements can be edited and approved online using electronic signatures and comment boxes. Additionally, the common information platform 12 can incorporate all bilateral agreements in airline employee affiliate searches (i.e., ZED, ID95, ID90, ID80, ID75, ID50, flat rates, SVC, reduced rate, or free of charge, and the like), including travel privileges offered by the employing airline.

Bilateral agreements can also be negotiated on an employee by employee basis. For example, Virgin Airlines can request a contract for an airline employee affiliate to travel on Alaska Airlines. Through the common information platform 12, Virgin Airlines can submit a proposed bilateral agreement that allows the airline employee affiliate to travel on Alaska Airlines. Alaska Airlines can accept the proposed contract or respond to the proposed contract with a counter-offer. Alternatively, Alaska Airlines may decline the proposed contract altogether. The process of contract offer, counter-offers, and declining contracts is part of the negotiation process.

If Alaska Airlines accepts the proposed contract from Virgin Airlines, Virgin Airlines receives an electronic communication via the common information platform 12 indicating that Alaska Airlines approved the requested contract. The approved contract is automatically uploaded to the common information platform 12. The contract is only enforceable during the term specified in the agreement. The contract automatically expires in the event that the airlines to the bilateral agreement state an expiration date.

If Alaska Airlines responds to Virgin Airlines proposed contract with a counter-offer, Virgin Airlines receives an electronic message via the common information platform 12 indicating such a response. Virgin Airlines may then directly link into the common information platform 12 to view the counter-offer by Alaska Airlines. The common information platform 12 displays the original contract offer from Virgin Airlines beside the new counter-offer contract from Alaska Airlines, including any notes. Virgin Airlines may accept the counter-offer, make another counter-offer, or decline the proposed contract altogether. Airlines can condition acceptance of the bilateral agreement only if reciprocity is granted. In this case both agreements (the original agreement and reciprocal agreement) are loaded into the common information platform 12 at the time of acceptance.

If Alaska Airlines chooses to decline the original contract offer from Virgin Airlines, Virgin Airlines receives an electronic message stating so. The electronic message may also include comments from Alaska Airlines.

As an added administrative control benefit to the airlines, the common information platform 12 stores bilateral contracts in several different categories. These categories include contracts awaiting approval, declined contracts, contracts requiring feedback, active contracts, and contracts set to expire within 60 days. For contracts awaiting approval, airlines may resubmit the contract to the receiving airline. The common information platform 12 also stores information on a complete history of all contracts, including declined contracts and any information pertaining thereto. Contracts requiring feedback include contract offers and counter-offer contracts from other airlines. Active contracts are sortable by alphabetical order, contract date, expiration date, date range, or other searchable field known in the art. Furthermore, contracts that expire in 60 days are highlighted.

Transporting airlines can also input embargo and flight restriction notices by flight number, range, or markets specific to each airline. Notification is automatically sent to all affected airlines and airline employee affiliates listed on the embargoed or restricted flights. Notification can occur by e-mail, text message, voice mail, or other electronic communication device associated with the airline employee affiliate. Listing embargos or restricted flights is airline specific. Expired embargoes and flight restrictions are automatically deleted from the common information platform 12.

The common information platform 12 is available twenty-four hours a day, seven days a week via a secure web-based protocol that is conveniently accessible from home, work, or while on the road. The common information platform 12 compiles and stores extensive airline employee affiliate statistics. Employing airlines can use this statistical data for cost-saving analysis (e.g., busiest day/hour and fare searching vs. email requests). Furthermore, the common information platform 12 includes an airline member contact directory, Federal Express delivery options (for an additional fee), and secure transfer of credit card information for e-mail ticket requests. The user-interface of the common information platform 12 includes age drop down boxes for dependents for fast age verification and allows for the addition or exclusion of employees of subsidiaries, affiliates, franchisees and alliance partners.

The web-based common information platform 12 also has a variety of employee benefits and support. For example, airline employee affiliates have access to multi-media instructional tutorials and live customer service via the phone or web-based application. The common information platform 12 includes a full schedule of airline flights continually updated by Official Airline Guide Inc. (OAG), a global content management company specializing in travel and transportation. OAG compiles flight details for over 1,000 airlines and more than 3,000 airports and travel service providers. The airline schedules provided by OAG are updated regularly. Embargo/flight restriction notices and airline pass policy information are also accessible to airline employee affiliates as previously discussed. Airline employee affiliates can make one-click travel reservation requests via a secure web-based protocol or intranet accessible, twenty-four hours a day, seven days a week. Fare searches include, but are not limited to, one-way, round trip, and multi-city travel (including flights with stops enroute), multiple carriers, (e.g., starting travel from LAX to LHR on United Airlines, continuing travel on British Airways from LHR to Hong Kong (HKG)), regional non-code-share flights (e.g., United Express flights operated by SkyWest), multiple languages, multiple fare restrictions (ZED, ID95, ID90, ID80, ID75, ID50, flat rate SVC, reduced rate, or free of charge, and other agreements of the like), and employing airline flight schedules. Airline employee affiliates may select multiple passengers and obtain an itinerary overview having fare subtotal (including taxes and all assorted fees).

The common information platform 12 can also create and store airline employee affiliate profiles. Profile data contains the following: name, date of birth, security questions, addresses, billing address, mailing address, dependents, telephone numbers, default airports, e-mail address, credit card information, and SMS text advice check box. The airline employee affiliate profile is also stored in association with flight information. Airline employee affiliate profiles can be validated by any of the methods discussed above.

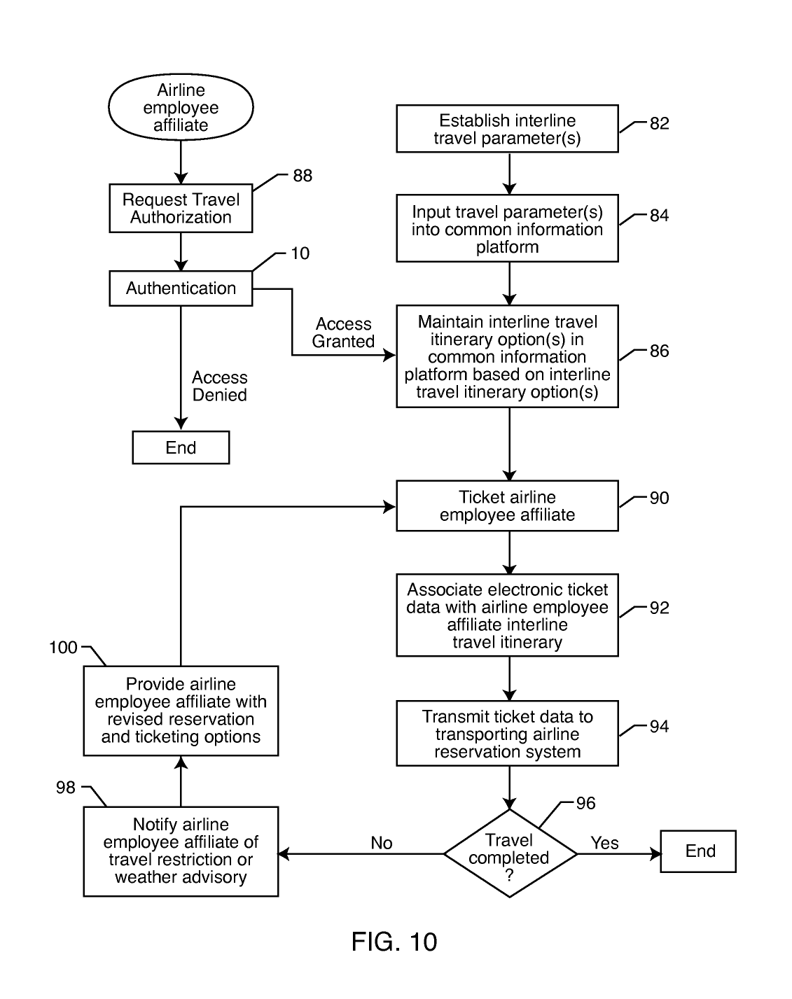

FIG. 10 illustrates a process for providing authorization to an airline employee affiliate for self-ticketing on the transporting airline. This process is particularly preferable because the airline employee affiliate is not required to contact the transporting airline in order to reserve and ticket an interline travel itinerary. The process first starts by establishing one or more interline travel parameter(s) (82) in the common information platform 12. The establishing step (82) preferably utilizes the common information platform 12 for negotiating the travel terms that define the interline travel parameters, in accordance with the embodiments described above. For instance, the employing airline may submit a contract through the common information platform 12, as described above, for consideration by the transporting airline. The transporting airline may accept, reject or otherwise counter-offer the travel parameters set forth in the request by the employing airline. Once the transporting airline and the employing airline come to an agreement as to the scope of permissible interline travel options, the parameters are established in the common information platform in accordance with step (82). Alternatively, the interline travel parameters may have previously been agreed and entered into between the employing airline and the transporting airline such that the parameters are simply uploaded or entered into the common information platform 12 (84). The interline travel parameters may be presented as a formal contract or as clause(s) or provision(s) within a contract. The contract itself may also be uploaded and/or entered into the common information platform 12 and associated with the interline travel parameters for use with the employing airline and the transporting airline.

The common information platform 12 uses the information that define the interline travel parameters to maintain interline travel itinerary option(s) in the common information platform 12 based on the interline travel itinerary option(s) (86) defined in the contract uploaded in accordance with step (84). The interline travel itinerary options may vary depending on different criteria. For example, executives employed by the employing airline may have more interline travel itinerary options than ticket agents. Thus, in one embodiment disclosed herein, the common information platform 12 maintains a database of available interline travel itinerary options that vary according to the employment status of the airline employee affiliate associated with the employing airline. In another example, family members or other relatives may have less interline travel itinerary options available relative to actual employees of the employing airline. The number of available itinerary options available and the expense associated with each of those options may vary depending on the origination, destination, flight duration, seating priority, seat assignment, connection quantity, or seat availability. The common information platform 12 may restrict (e.g. not show) certain interline travel itinerary options to airline employee affiliates (e.g. such as family members), while presenting those restricted interline travel itinerary options to executives of the employing airline. Accordingly, the terms of the contract between the employing airline and the transporting airline should define the travel options for one or more airline employee affiliate groups associated with the employing airline.

As such, the airline employee affiliate is capable of self-ticketing themselves without contacting the transporting airline in accordance with the steps disclosed with respect to FIG. 10. The first step is for the airline employee affiliate to request a travel authorization (88). In one embodiment, the airline employee affiliate contacts the employing airline for the travel authorization. For example, the airline employee affiliate may call the employing airline to speak with a booking agent or other representative to obtain the travel authorization over the phone. Alternatively, the airline employee affiliate may obtain the travel authorization by contacting the employing airline electronically. In this embodiment, the airline employee affiliate may use a computer or other internet/intranet enabled device to request the travel authorization through a web site operated by the employing airline or through an employing airline intranet. The employing airline then generates the travel authorization for use with the common information platform 12.

Next, the airline employee affiliate must access the common information platform 12. At this stage, it is not necessary for the airline employee affiliate to have previously obtained the travel authorization from the employing airline because it is also possible to obtain the travel authorization directly from the common information platform 12. In either embodiment, the airline employee affiliate must perform the authentication step (10), as described in detail above, to be granted access to the common information platform 12. If the airline employee affiliate has not previously obtained a travel authorization through the employing airline, the common information platform 12 may generate such a travel authorization so that the airline employee affiliate may search for interline travel based on the travel parameters established between the employing airline and the transporting airline. The common information platform 12 may automatically generate the travel authorization based on credentials provided during the authentication step (10), such as a user name/password. If the common information platform 12 automatically generates the travel authorization, it is not necessary for the airline employee affiliate to contact the employing airline prior to searching for an interline travel itinerary. In fact, it is preferable that the airline employee affiliate be able to bypass contacting either the employing airline or the transporting airline to further facilitate the self-ticketing process described with respect to FIG. 10.

Once the airline employee affiliate accesses the common information platform 12 and has a travel authorization, the common information platform 12 presents a list of interline travel itinerary options available to that particular airline employee affiliate. The common information platform 12 associates the travel authorization provided by the airline employee affiliate with the interline travel parameters defined in the agreement between the employing airline and the transporting airline. Thus, the airline employee affiliate is only able to see and, therefore, book interline travel options falling within the scope of the interline travel parameters defined in the contract between the employing airline and transporting airline. This is certainly beneficial as it streamlines the process of booking positive-space available seating with the transporting airline. One particular advantage to this embodiment is that the airline employee affiliate is able to book an interline travel itinerary without using the resources of either the employing airline or the transporting airline. The airline employee affiliate is also able to see how much each interline travel itinerary option costs in terms of the interline travel fee calculators described above. The agreement between the employing airline and the transporting airline may use one or more methods of calculating the fee the airline employee affiliate must pay to travel with the interline travel itinerary.

Next, the airline employee affiliate selects one of the interline travel options for airline travel on the transporting airline. At this point, the common information platform 12 tickets the airline employee affiliate (90). The common information platform 12 then associates electronic ticket data with the airline employee affiliate interline travel itinerary (92). The electronic ticket data is then transmitted to the transporting airline reservation system (94). This ensures that the airline employee affiliate obtains a reservation and ultimately a ticket for travel on the transporting airline, within the scope of the interline travel parameters established in step (82). The airline employee affiliate is then scheduled to travel according to the interline travel itinerary. The reservation and ticket are merely a “privilege” as opposed to a “benefit”. That is, either the employing airline or the transporting airline may unilaterally revoke the reservation and/or ticket for travel on the transporting airline because interline travel, in general, is a privilege as opposed to a benefit. Benefits, on the other hand, cannot be unilaterally taken away from the airline employee affiliate. Accordingly, the employing airline and/or the transporting airline maintain greater control over the issuance and use of interline travel reservations by airline employee affiliates by categorizing the reservation and ticket as a “privilege” as opposed to a “benefit”.

Next, it must be determined whether the airline employee affiliate successfully completed travel (96). In the event that the airline employee affiliate was able to board the transporting airline and successfully complete the interline travel itinerary, the system merely logs the successfully completed travel itinerary to the account associated with that particular airline employee affiliate. On the other hand, if travel was not successfully completed, the common information platform 12 may notify the airline employee affiliate of a travel restriction or a weather advisory (98) that may have had an affect on whether the airline employee affiliate was able to complete travel to the desired destination. The common information platform 12 may contact the airline employee affiliate through an automated SMS text message, an automated phone call, or by some other automated or manual means known in the art. Preferably, the common information platform 12 is able to provide the airline employee affiliate with revised reservation and ticketing option(s) (100). The airline employee affiliate then has the option to select a particular travel itinerary that gets the airline employee affiliate to the desired destination. The process of selecting, ticketing, associating and transmitting are substantially similar to those processes described with respect to steps (90)-(94).

Although several embodiments have been described in some detail for purposes of illustration, various modifications may be made without departing from the scope and spirit of the invention. Accordingly, the invention is not to be limited, except as by the appended claims.

What is claimed is:

1. A process for reserving and ticketing space-available seats to an airline employee affiliate associated with an employing airline for travel on a transporting airline, the steps comprising:
providing a common information platform containing flight information and airline employee affiliate information for reserving and ticketing non-revenue interline travel;
establishing an interline travel parameter in the common information database governing reservation and ticketing options for the airline employee affiliate;
processing a travel authorization issued by the employing airline and associated with the interline travel parameter;
ticketing the airline employee affiliate with an interline travel itinerary on the transporting airline within the scope of the interline travel parameter;
associating electronic ticket data with the interline travel itinerary; and
transmitting the electronic ticket data and the interline travel itinerary to the transporting airline reservation system.

2. The process of claim 1, including the step of facilitating self-ticketing of the airline employee affiliate with the travel authorization through the common information platform.

3. The process of claim 2, wherein the facilitating step occurs without contacting the transporting airline.

4. The process of claim 1 or 2, including the step of notifying the airline employee affiliate of a flight restriction or a weather advisory via an electronic message.

5. The process of claim 4, including the step of providing the airline employee affiliate with a revised reservation and ticking option based on a transporting airline load factor or a stand-by list.

6. The process of claim 1 or 2, wherein the interline travel parameter includes departure day or time, arrival day or time, flight duration, seating priority, seat assignment, connection quantity, or seat availability.

7. The process of claim 1 or 2, wherein the establishing step includes the step of adding a contract provision into the common information platform, the contract provision defining multiple interline travel parameters between the employing airline and the transporting airline.

8. The process of claim 7, including the step of limiting the travel authorization for non-revenue interline travel on the transporting airline based on the multiple interline travel parameters.

9. The process of claim 1 or 2, including the step of receiving the travel authorization from a representative of the employing airline.

10. The process of claim 1 or 2, including the step of retrieving transporting airline fares within the scope of the interline travel parameter using an interline fare calculator accessible through the common information platform.

11. The process of claim 1 or 2, including the step of verifying eligibility of the airline employee affiliate to access the common information platform to reserve and ticket non-revenue interline travel with the travel authorization by retrieving access information from an employer database or the common information platform.

12. The process of claim 1 or 2, wherein the interline travel parameter includes a space-available or a positive-space available seating option on the transporting airline.

13. The process of claim 12, wherein the space-available or the positive-space available seating option includes a first class ticket.
